(19) United States
(12) Patent Application Publication
(10) Pub. No.: US 2017/0034083 A1
(43) Pub. Date: Feb. 2, 2017

(54) GEOLOCATION- AND TIME-BASED ALERTS THAT IDENTIFY CLIENT DEVICES IN GEOGRAPHIC AREAS

(71) Applicant: Breadcrumbs Labs, LLC, New York, NY (US)

(72) Inventor: Ross William Deutsch, New York, NY (US)

(21) Appl. No.: 15/193,365

(22) Filed: Jun. 27, 2016

Related U.S. Application Data
(60) Provisional application No. 62/197,344, filed on Jul. 27, 2015.

(51) Int. Cl. H04L 12/58; H04W 4/02; H04L 29/08

(52) U.S. Cl. CPC H04L 51/04; H04L 67/306; H04W 4/028; H04L 51/38

(57) ABSTRACT

Disclosed are various embodiments for geolocation- and time-based alerts that identify client devices that were in a specified geographic area at a specified time. A user of a client application may designate an alert that comprises a message, a specified geographic area or location, and a specified time. A computing environment that maintains geolocation data for various client devices may identify those client devices that were in the specified geographic area at the specified time and may communicate the alert to those client devices. A communication session may be established between a user who originated the alert and at least one other user of another client device.

### CROSS-REFERENCE TO RELATED APPLICATION

This application claims the benefit of and priority to co-pending U.S. Provisional Patent Application No. 62/197,344 entitled “GEOLOCATION- AND TIME-BASED ALERTS THAT IDENTIFY CLIENT DEVICES IN GEOGRAPHIC AREAS,” filed on Jul. 27, 2015, the contents of which are incorporated by reference in their entirety herein.

### BACKGROUND

Geolocation relates to the identification of a real-world geographic location of an object or a person using, for example, a client device of the person. Geolocation may be accomplished using modules of a client device, such as a global positioning system (GPS) module or a wireless fidelity (WiFi) module of a smartphone or tablet.

The Global Positioning System (GPS) is a space-based navigation system capable of providing time and location data at any location on the planet in a variety of weather conditions. WiFi is a communication media that enables devices to connect to a wireless LAN (WLAN) network, predominantly over the 2.4 gigahertz (12 cm) UHF and 5 gigahertz (6 cm) SHF ISM radio bands. A WLAN is usually password protected, but may be open, which allows any device within its range to access the resources of the WLAN network. WiFi can be used in localization techniques to identify a location of a device attempting to or connecting to a WLAN.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is another drawing of the networked environment of FIG. 1 according to various embodiments of the present disclosure.

FIGS. 3-14 are drawings of example user interfaces of a client application executed by a client application of the networked environment of FIG. 1 according to various embodiments of the present disclosure.

FIG. 15 is a flowchart illustrating example functionality implemented by an alert management application executed in a computing environment in the networked environment of FIG. 1 according to various embodiments of the present disclosure.

FIG. 16 is a flowchart illustrating example functionality implemented by a client application executed in a client device in the networked environment of FIG. 1 according to various embodiments of the present disclosure.

FIG. 17 is a flowchart illustrating example functionality implemented in the networked environment of FIG. 1 according to various embodiments of the present disclosure.

FIGS. 18 and 19 are schematic block diagrams that provide example illustration of a computing environment and a client device employed in the networked environment of FIG. 1 according to various embodiments of the present disclosure.

### DETAILED DESCRIPTION

The present disclosure relates to data processing of geolocation- and time-based alerts to identify client devices in geographic areas. Various embodiments described herein provide a social network, allowing users who may have missed one another in a particular location to later connect. As noted above, geolocation relates to the identification of a real-world geographic location of an object or a person using, for example, a client device of the person. Geolocation may be accomplished using modules of a client device, such as a global positioning system (GPS) module or a wireless fidelity (WiFi) module of a smartphone or tablet.

Further, users of client devices may desire to contact other users who were located in a same region at the same time. For example, if John Smith was at a coffee shop, John may have noticed an attractive woman as she was leaving the coffee shop. As John did not get the opportunity to speak with the woman, it may be unlikely and even impossible for John to meet the woman in the future.

While client devices may be equipped with GPS and WiFi modules and associated capabilities, a client device cannot identify whether a person or device was in a particular location at a particular time. Further, the client device cannot identify whether a person or device was in a same location as the client device. To this end, a technological problem exists as an individual client device is incapable of identifying other people devices that were in a same location at a same time, where the identification is performed well beyond the devices having left the location.

Embodiments as will be described herein, provide a technological solution by providing a back-end computing environment that maintains a data store associated with locations of a client device at particular times, thereby allowing a first user to identify and communicate with a second user who was at the same location at the same time, although at a time in the future. Instances of a same client application can be provided to the client devices to interact with the back-end computing environment. As such, the embodiments described herein provide an improvement in location systems as well as an improvement in software applications for client devices capable of locating and communicating with other device users.

Accordingly, it may be beneficial for a client application to allow users to create messages that are pushed to users who were in the same location at the same time. The messages may be created at a future time as the users may not be in the same location at the same time.

According to various embodiments, a computing environment is employed to access notifications, referred to herein as alerts, generated by users of the client application on their client devices. In some embodiments, the alert comprises a message provided by a user of the client device. With respect to the example of John glancing at an attractive woman leaving a coffee shop, John may provide a description of the woman and his location when he saw the woman. The alert may be communicated to user devices that were in proximity to John's device at a particular time. Assuming the woman utilizes the client application, she may be provided the alert in a feed and decide whether to initiate communication with John.

To identify users that will receive the alert, the computing environment may access geolocation data received from various client devices, such as users of the client application, as they travel about their day. The geolocation data may comprise locations of users as well as timestamps indicating the time at which the users were at those particular locations. The client devices that were located within a predefined distance of John at the coffee shop and within a same time period can be identified using the geolocation data.

The alert generated by John can be communicated to the identified client devices. In some embodiments, the client applications executing on respective ones of the client devices can encode the alert generated by John, as well as other alerts, in a feed. Users can navigate their feed on their device to see if anyone has generated an alert with their description.

Further, the client application can allow the users to indicate whether they are the person described in the message. For example, the users may indicate that they are the woman identified in John's description. If they indicate that they are the person described in the message, they may be provided information from John's user profile. Similarly, John may receive profile data from users who claim to be the woman described in John's message.

As some people may falsely claim to be the woman identified in John's message, the client application may provide a review process, where John can navigate through users claiming to be the woman in the coffee shop and select one of the users who John knows to be the woman. After John has confirmed one of the users as, in fact, being the woman in the message, the client application may facilitate communication between John's device and the woman's device. Communication may be achieved by, for example, providing an electronic chat session between the users or allowing the users to connect via a social networking platform.

The geolocation data obtained from John's device, as well as other client devices executing the client application, may be obtained using at least one location module of the client device, such as a GPS module, a WiFi module, or other suitable location module. For example, various localization techniques can be employed to identify a location of the client device, such as measuring the intensity of the received signal (received signal strength indication or RSSI) and employing “fingerprinting.” Other parameters useful to geolocate a client device or a Wi-Fi hotspot or wireless access point communicatively coupled to the client device include the SSID and the MAC address of the access point which can be used to query a data base of known location of wireless access points. The possible signal fluctuations that may occur can increase errors and inaccuracies in the path of the user. To minimize fluctuations in the received signal, in some embodiments, techniques can be applied to filter noise.

In the following discussion, a general description of the system and its components is provided, followed by a discussion of the operation of the same.

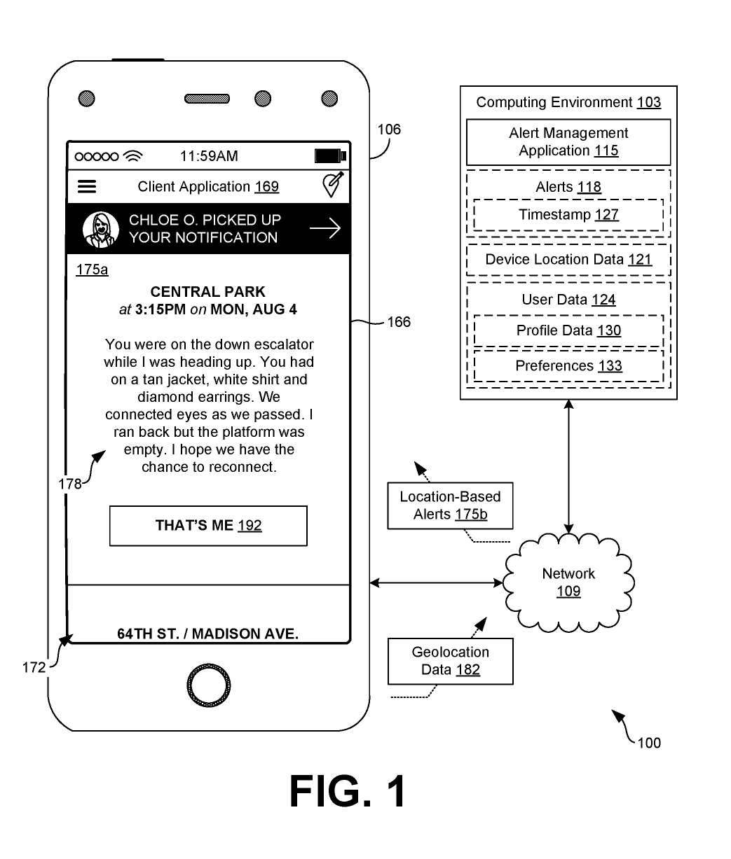

With reference to FIG. 1, shown is a drawing of a networked environment 100 according to various embodiments. The networked environment 100 includes a computing environment 103 and a client device 106, which are in data communication with each other via a network 109. The network 109 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 103 may comprise, for example, a server computer or any other system providing computing capability. Alternatively, the computing environment 103 may employ a plurality of computing devices that may be arranged, for example, in one or more server banks, computer banks or other arrangements. Such computing devices may be located in a single installation or may be distributed among many different geographical locations. For example, the computing environment 103 may include a plurality of computing devices that together may comprise a hosted computing resource, a grid computing resource and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include an alert management application 115, and other applications, services, processes, systems, engines, or functionality not discussed in detail herein. The alert management application 115 is executed to manage alerts generated by users of various instances of a client application executed on various client devices 106. Managing alerts may include, for example, identifying client devices that were in a same location or region at the same time as a user who generated an alert and communicating the alert to those devices.

The data stored in the data store 112 includes, for example, alerts 118, device location data 121, user data 124, and potentially other data. The alerts 118 may comprise communications generated by users of the client devices 106. In some embodiments, data for the alerts 118 include messages generated by users that describe other users. For example, John may identify a hair color, an eye color, or the clothes of the woman he saw leaving the coffee shop. The alerts 118 generated by users may be communicated to applicable client devices 106, as will be discussed.

In various embodiments, device location data 121 includes geolocation data obtained from location modules of the client devices 106. Location modules may include GPS modules, WiFi modules, or other modules capable of locating the client device 106. In some embodiments, the device location data 121 may comprise location data collected from a social networking platform, such as a location of a restaurant, hotel, or other business when the user “checks in” on the social networking platform. The social networking platform may comprise, for example, FACEBOOK®, GOOGLE+®, INSTAGRAM®, TWITTER®, FOURSQUARE®, or other social networking platform that collects data regarding locations of a user or a client device 106 of the user. The device location data 121 may further comprise a timestamp 127 that identifies a time or a range of time a user was in a particular location or geolocation.

User data 124 may include, for example, profile data 130 and/or preferences 133. The profile data 130 may include data provided by a user via a client application or a social networking platform. In various embodiments, the profile data 130 includes a city, state, and/or country in which the user resides; gender; relationship status (e.g., single, married, in a relationship); one or more pictures of the user; and/or other information. Preferences 133 may include user-defined constraints regarding types of users with whom a particular user desires to interact with. For example, a user John Smith may define that he wants to interact with females aged 21-25 years of age.

The client device 106 is representative of a plurality of client devices that may be coupled to the network 109. The client device 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 106 may include a display 166. The display 166 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 106 may be configured to execute various applications such as a client application 169 and/or other applications. The client application 169 may be executed in a client device 106, for example, to access network content served up by the computing environment 103 and/or other servers, thereby rendering a user interface 172 on the display 166. To this end, the client application 169 may comprise, for example, a dedicated application (e.g., a mobile application), a web browser application, etc., and the user interface 172 may comprise a network page, an application screen, etc. The client device 106 may be configured to execute applications beyond the client application 169 such as, for example, email applications, social networking applications, word processors, spreadsheets, and/or other applications.

Next, a general description of the operation of the various components of the networked environment 100 is provided. To begin, various instances of the client application 169 may be installed and/or executed on a multitude of client devices 106. The client application 169 may include an application that allows users to create messages that are pushed to users who were in the same location at the same time. The messages may be created at a future time as the users may not be in the same location at the same time.

The computing environment 103 is employed to access alerts 175a . . . 175b (hereinafter alerts 175), generated by users of the client application 169. In some embodiments, an alert 175 comprises a message 178 provided by a user of a client device 106, a location associated with the message 178 (e.g., “Central Park”), a time the user was at the location (e.g., “3:15 PM on Monday, August 4”), and/or other information. With respect to the example of FIG. 1, a user may create a message 178 that describes an appearance of a person the user saw at a particular location. In some embodiments, the computing environment 103 may communicates the alert 175 to client devices 106 that are or were in proximity to the originating client device 106 at the time the alert 175 was created or at a time specified by the user when creating the alert 175.

To this end, the computing environment 103 may collect geolocation data 182 from each of the client devices 106 that execute instances of the client application 169 as they travel from location to location. The geolocation data 182 may comprise locations of users as well as times at which the users were at those particular locations. The client devices 106 that were located within a predefined distance of a client device 106 that generates an alert 175 at a same or similar time may receive the alerts 175.

As a non-limiting example, John may visit Central Park in New York City and see a woman who he'd like to connect with. John may generate an alert 175 that includes a message 178 describing a woman he saw at Central Park. The alert 175 generated by John can be communicated to the client devices 106 that were in or around Central Park at or about 3:15 PM on Monday, August 4. The client applications 169 can render alerts 175 generated by John, as well as other alerts 175, in a feed of the user interface 172.

Further, the client application 169 can allow the users to indicate whether they are the person described in the message 178. For example, if a user thinks that he or she was described in the message 178, the user may select or otherwise manipulate an identification component 192 (labelled “THAT'S ME”). The computing environment 103 may detect the manipulation by receiving a suitable communication from the client application 169. If they indicate that they are the person described in the message, they may be provided information from John's user profile. Similarly, John may receive profile data from users who claim to be the woman described in John's message.

As some people may falsely claim to be a person described in a message 178, the client application 169 may provide a review process, where an originating client device 106 may provide profile information on users claiming to be a person identified in the message 178. Further, the client application 169 facilitates a selection of at least one of the users such that the client application 169 provides a communication component that allows bi-lateral communication between an originating client device 106 and a client device 106 of a person described in the message 178. Bi-lateral communication may be achieved by providing an electronic chat session between the users or allowing the users to connect via a social networking platform, for example.

The geolocation data 182 obtained from the client device 106, as well as other client devices 106 executing instances of the client application 169, may be obtained using at least one location module of the client device, such as a GPS module, a WiFi module, or other suitable location module.

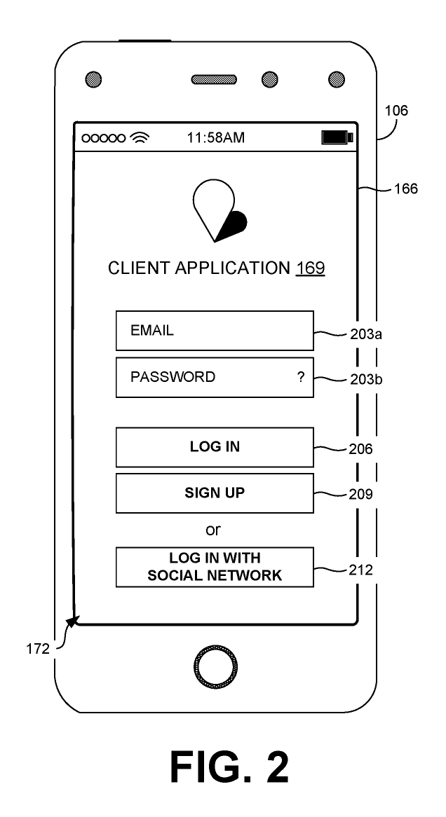

Referring next to FIG. 2, shown is an example of a user interface 172 of the client application 169 according to various embodiments. To access features of the client application 169, the client application 169 may require a user to provide authentication data collected from the user during a sign up process. For example, the user may provide an e-mail address, a password, or other information in suitable form fields 203a . . . 203b (collectively form fields 203).

By selecting a log in component 206, the client application 169 may communicate with the computing environment 103 to validate the authentication credentials. By selecting a sign up component 206, the client application 169 may collect authentication data from the user to be used in subsequent sessions. In various embodiments, the sign up process includes generating one or more subsequent user interfaces 172 that collect profile data from the user including, but not limited to, a first name, a last name, a phone number, a height, a weight, an eye color, photos, employment history, etc.

In various embodiments, the client application 169 allows a user to authenticate using a social networking profile of the user. For example, the user can authorize a social network (e.g., FACEBOOK®, GOOGLE+®, INSTAGRAM®, TWITTER®, or FOURSQUARE®) to provide profile information to the client application 169 and/or the computing environment 103. The data provided from the social network may include, for example, a first name, a last name, a phone number, a height, a weight, an eye color, photos, employment history, etc.

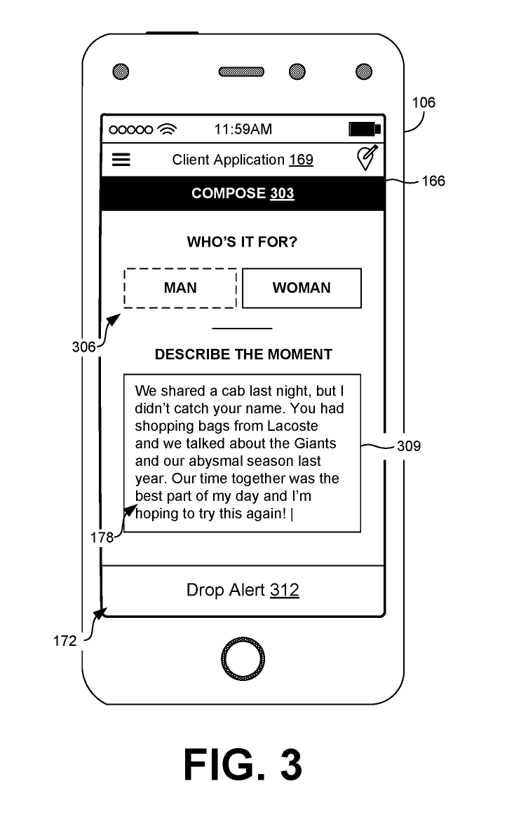

Turning now to FIG. 3, shown is an example of another user interface 172 of the client application 169 according to various embodiments. The client application 169 may generate a compose screen 303 that allows a user to create an alert 175. In various embodiments, the compose screen 303 comprises a field 306 that allows the user to specify whether a gender of the person described in the message 178 is a male or a female. As may be appreciated, the computing environment 103 will only make the alert 175 accessible to those who have specified the same gender in his or her user profile.

A text input field 309 of the compose screen 303 allows users to input a message 178 using a suitable input device, such as a physical or virtual keyboard. In various embodiments, the message 178 describes a person who the user saw in a location at a particular time. The client application 169 may allow the user to specify the location and/or the time such that the computing environment 103 makes the alert 175 accessibly to client device 106 in the specified location at the specified time. In other embodiments, the computing environment 103 utilizes a current location of the client device 106 and a time the alert 175 was generated, for example, by a selection of a drop alert component 312.

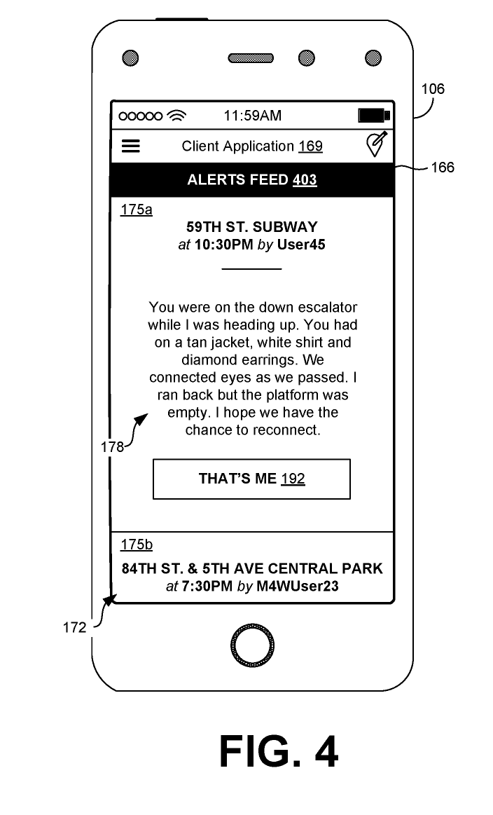

Moving on to FIG. 4, shown is an example of another user interface 172 of the client application 169 according to various embodiments. The client application 169 may receive alerts 175 from the computing environment 103 for display in an alerts feed 403. As may be appreciated, the alerts feed 403 may comprise alerts 175a . . . 175b received by the client device 106 that are applicable to a user of the client device 106. For example, the alerts 175 may include those associated with a time, location, and/or matching user profile data specified by an originator of the alert 175.

In the example of FIG. 4, the client device 106 was located at the “59^{th} St. Subway at 10:30 PM” (e.g., indicated by the first alert 175a) and at “84^{th} St. and 5^{th} Ave. Central Park at 7:30 PM” (e.g., indicated by the second alert 175b). If the client device 106 was not at the location at the specified time on the specified day, the alerts 175 would not be shown in the alerts feed 403.

Accordingly, the user of the client device 106 may read the alerts 175 to determine whether he or she is described in a message 178. The client application 169 allows the users to indicate whether they are the person described in the message 178. For example, if a user thinks that he or she was described in the message 178, the user may select or otherwise manipulate an identification component 192 (labelled “THAT'S ME”). The computing environment 103 may detect the manipulation by receiving a suitable communication from the client application 169.

In some embodiments, if the user indicates that he or she is the person described in an alert 175, the computing environment 103 may provide the client device 106 with information from a profile of the user that created the alert 175. Similarly, the computing environment 103 may provide the client device 106 with information from a profile of the user that selected the identification component 195 for the user that originated the alert 175.

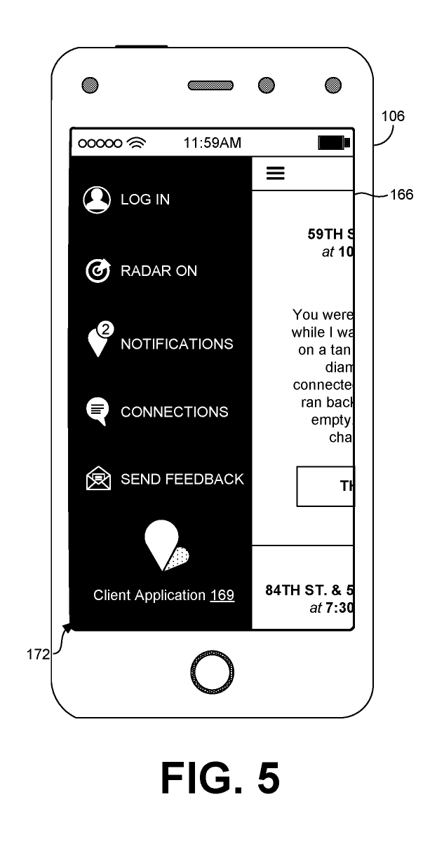

Referring next to FIG. 5, shown is an example of another user interface 172 of the client application 169 according to various embodiments. The client application 169 may comprise a toolbar component 503 that allows a user to log in to the client application 169 (e.g., “LOG IN”), toggle (e.g., enable or disable) an ability of the client application 169 to utilize a location module of the client device 106 (e.g., “RADAR ON”), access new alerts 175 (e.g., “NOTIFICATIONS” where the “2” in the icon denotes two new alerts 175), access connections created between users (e.g., “CONNECTIONS”), send feedback (e.g., “SEND FEEDBACK”), or other functions. Connections created between users may include those that connected through an alert 175 where a first user created the alert 175 and a second user accepted the alert 175.

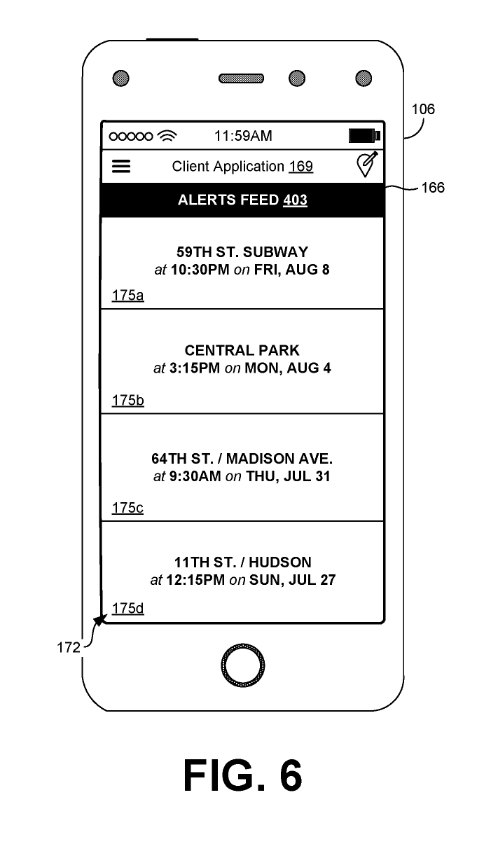

Turning now to FIG. 6, shown is an example of another user interface 172 of the client application 169 according to various embodiments. The alerts feed 403 includes alerts 175a . . . 175d that are identified for the client device 106 by the computing environment 103 and communicated to the client device 106 for rendering in the display 166. In the example of FIG. 6, assuming the client device 106 was located at the “59^{th} St. Subway” at or around 10:30 PM on Friday, August 8,” a corresponding alert 175 may be communicated to the client device 106 for rendering in the alerts feed 403. Similarly, assuming the client device 106 was located at “Central Park” at or around 3:15 on Monday, August 4, a corresponding alert 175 may be communicated to the client device 106 for rendering in the alerts feed 403. If the client device 106 was not at the location at the specified time on the specified day, the alerts 175 would not be shown in the alerts feed 403.

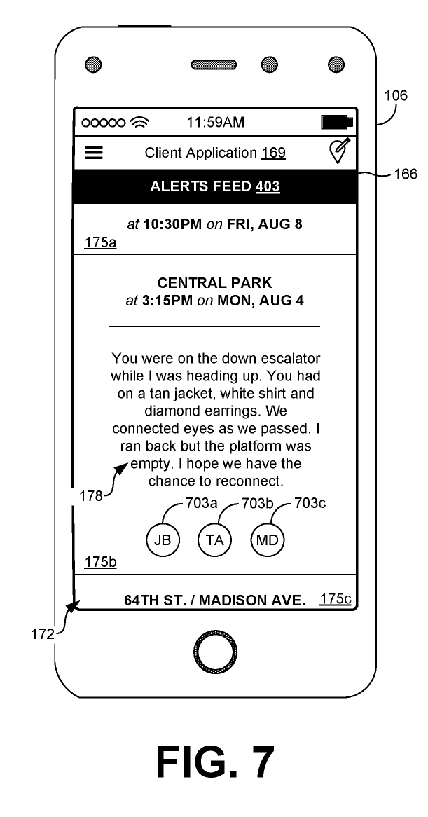

Moving on to FIG. 7, shown is an example of another user interface 172 of the client application 169 according to various embodiments. When individual ones of the alerts 175a . . . 175c are selected or otherwise manipulated, a selected one of the alerts 175 may expand to show further information associated with the alert 175. For example, when the alert 175b shown in FIGS. 6-7 is manipulated, the information associated with the alert 175b can be presented, such as the message 178 associated with the alert 175b.

Further, the alerts feed 403 may include information associated with those who have viewed and/or accepted an alert 175 (e.g., by selecting or manipulating the identification components 192). For example, icons 703a . . . 703c may be shown that comprise initials of a user who has viewed and/or accepted the alert 175.

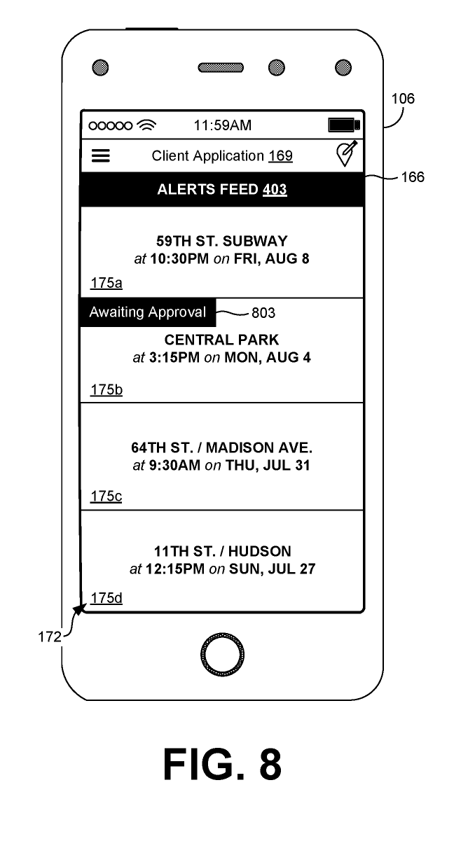

Referring next to FIG. 8, shown is an example of another user interface 172 of the client application 169 according to various embodiments. As discussed above, the alerts feed 403 shows a plurality of alerts 175a . . . 175d. Some of the alerts 175 may require approval before being pushed to users of the client application 169. Accordingly, for alerts 175 awaiting approval from an administrator, a label 803 that indicates that an alert 175 is awaiting approval may be encoded in the user interface 172 for display on the client device 106.

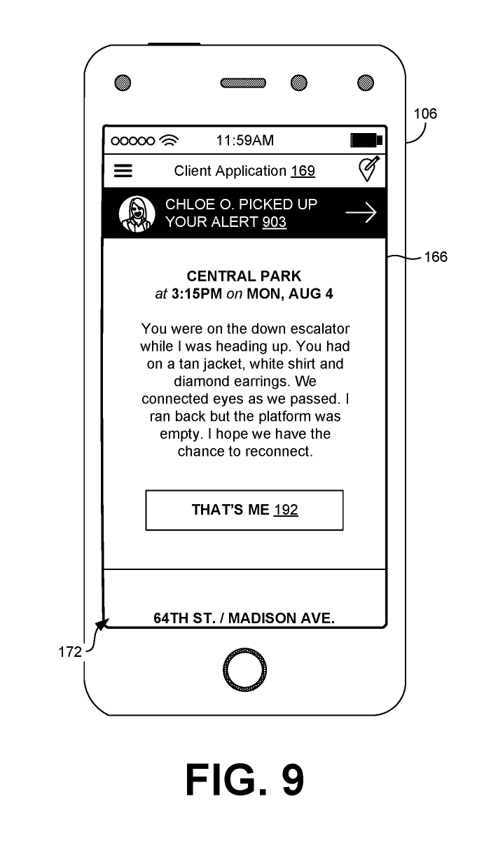

Moving on to FIG. 9, shown is an example of a user interface 172 of the client application 169 according to various embodiments. As the user navigates various screens, network pages, or other user interfaces 172 of the client application, the user may be notified when certain events occur, for example, by presenting information associated with the event in a suitable portion of the user interface 172 that notifies the user without distracting the user from other components of the user interface 172. For example, if another user (e.g., “Chloe O.”) accepts an alert 175 generated by the user of the client device 106, the user may be alerted in an event component 903.

In various embodiments, the event component 903 may be shown in the user interface 172 until the user selects or otherwise manipulates the event component 903. In other embodiments, the event component 903 may be rendered in the display 166 for a predefined amount of time (e.g., five to ten seconds). The selection or manipulation of the event component 903 may generate subsequent user interfaces 172 that present the user with information about the user that accepted the alert 175. Further, the event component 903 may comprise information associated with the user that accepts the alert 175 including a profile picture, a first name, a last name, a first initial, a last initial, or other profile information.

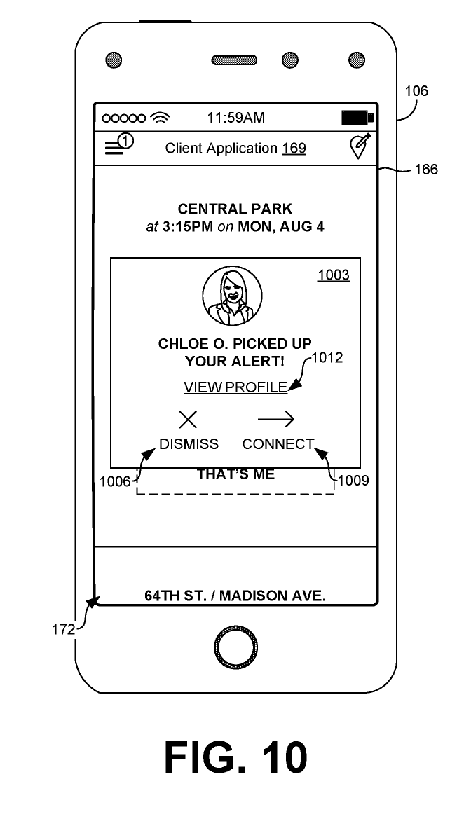

Referring next to FIG. 10, shown is an example of a user interface 172 of the client application 169 according to various embodiments. Notable events may also be presented to the user via a dialog 1003, such as a user interface component that is overlaid on a particular user interface 172. The dialog 1003 may present information associated with the event in a suitable portion of the user interface 172. For example, if another user (e.g., “Chloe O.”) accepts an alert 175 generated by the user of the client device 106, the user may be alerted in via the dialog 1003.

In various embodiments, the dialog 1003 may be shown in the user interface 172 until the user selects or otherwise manipulates a dismiss component 1006, a connect component 1009, and/or a view profile component 1012. In other embodiments, the dialog 1003 may be rendered in the display 166 for a predefined amount of time (e.g., five to ten seconds). The selection or manipulation of the dismiss component 1006 may remove the dialog 1003 from the user interface 172. The selection or manipulation of the connect component 1009 may generate subsequent user interfaces 172 that present the user with information about the user that accepted the alert 175, cause the computing environment 103 to form an association between the two users, and/or present the user with a communication component that allows the user to communicate with one another. A manipulation of the view profile component 1012 may generate one or more user interfaces 172 that comprise profile information associated with the user that accepts the alert 175, such as a profile picture, a first name, a last name, a first initial, a last initial, or other profile information.

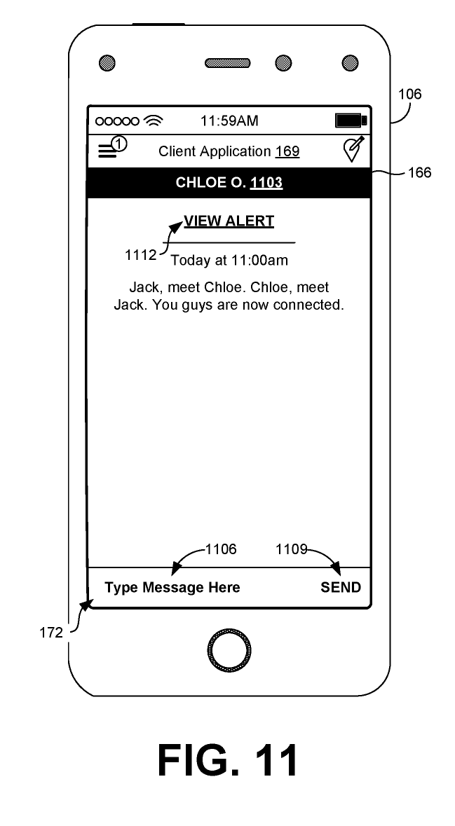

Turning now to FIG. 11, shown is an example of another user interface 172 of the client application 169 according to various embodiments. When the connect component 1009 of the user interface 172 of FIG. 10 is selected or manipulated, a communication screen 1103 may be shown in the client application 169 that allows users to communicate with one another, for example, via electronic text messages, video chat, or voice chat.

For example, a user may select or otherwise manipulate an input text field 1106 to input text using a physical or virtual keyboard. The user may select or otherwise manipulate a send component 1109 that communicates the input in the input text field 1106 to the computing environment 103 to facilitate communication of the messages between client devices 106. In some situations, a user may need to be reminded of the alert 175 which prompted the connection between users and the communication session. To this end, the user may select or otherwise manipulate a view alert component 1112 to view the alert 175 that prompted the connection and/or communication session.

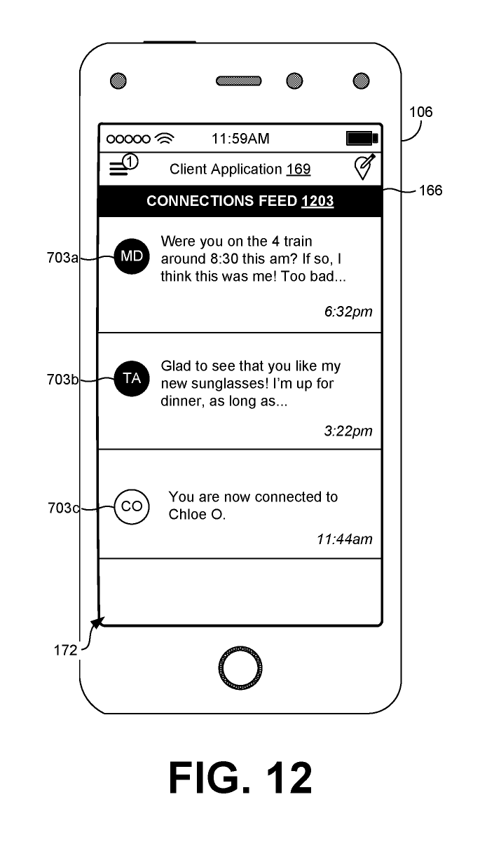

Moving on to FIG. 12, shown is an example of another user interface 172 of the client application 169 according to various embodiments. A connections feed 1203 may include connections that were created between users. For example, assuming John created an alert 175 and Jane accepted the alert 175, Jane would be included in a connections feed 1203 on John's client device 106 and John would be included in a connections feed 1203 on Jane's client device 106. A selection or other manipulation of individual ones of the connections may cause a subsequent user interface 172 to be generated comprising a communication component that allows the users to perform bi-lateral communication.

To this end, the connections feed 1203 may comprise a list of connections made between a user and various other users of the client application 169. For each of the connections in the list, a last message made between the users may be shown (as well as the time of the last message) or, if no messages have been communicated, a default message (e.g., “You are now connected to Chloe O.”) may be shown. Icons 703a . . . 703c may identify a user associated with a connection using, for example, initials. In other embodiments, a profile picture may be shown for each of the connections in the connection feed 1203.

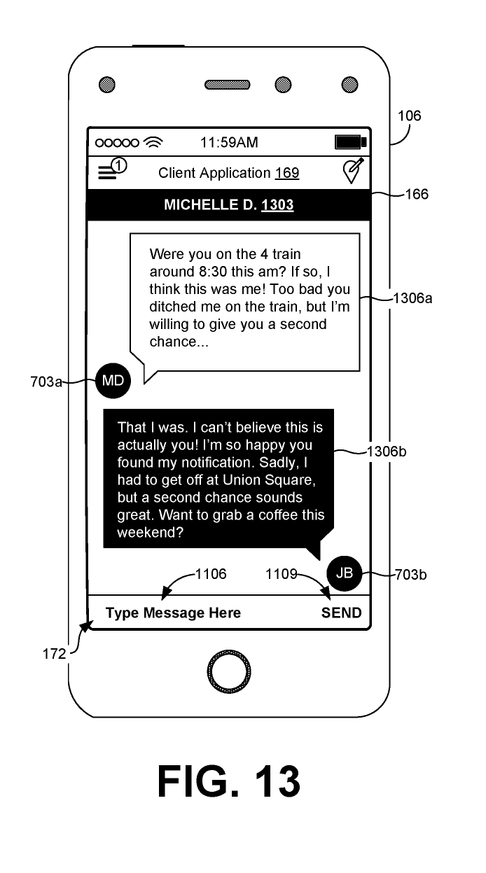

Referring next to FIG. 13, shown is an example of another user interface 172 of the client application 169 according to various embodiments. When a user selects a connection in the connections feed 1203, the client application 169 may show a user interface 172 for a communication session 1303 where a first user may communicate with a second user by sending chat messages 1306a . . . 1306b (collectively chat messages 1306), such as text messages, voice messages, video messages, or other messages. As may be appreciated, one of the users in the communication session 1303 may include a user who originated an alert 175 and another one of the users may include a user who accepted an alert, e.g., indicated that he or she was the person described in a message 178 of the alert 175.

To send a chat message 1306, a user may select or otherwise manipulate the input text field 1106 to input text using a physical or virtual keyboard. Once text has been provided in the input text field 1106, the user may select or otherwise manipulate the send component 1109 to communicate the input to the computing environment 103 to facilitate communication of the messages between client devices 106. The computing environment 103 accordingly causes the display of the chat messages 1306 in corresponding client devices 106 (e.g., the originator of the alert 175 and the acceptor of the alert 175). Icons 703a . . . 703b may be shown in association with the chat messages 1306 that comprise initials of a user who generated the chat message 1306. In some embodiments, the icons 703 may comprise a profile picture of the user.

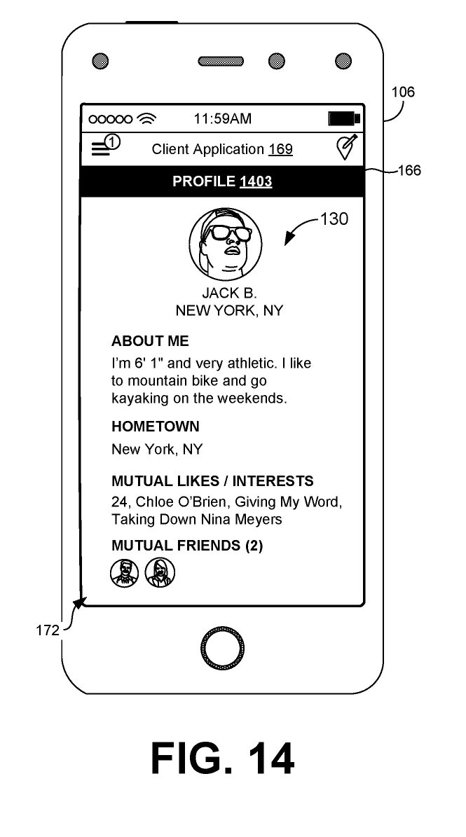

Turning now to FIG. 14, shown is an example of another user interface 172 of the client application 169 according to various embodiments. A profile screen 1403 may show information provided by a user of the client application 169. The information shown in the profile screen 1403 may include profile data 130 accessed from memory of the computing environment 103 or other memory.

In various embodiments, the profile data 130 includes information provided by a user using forms of the client application 169. In other embodiments, the profile data 130 includes information collected from a social networking profile of a user. The client application 169 can further facilitate the customization and/or modification of a user profile.

In various embodiments, when a user accepts an alert 175 (e.g., by selecting the identification component 192 indicating that the user is the person described in the message 178), the accepting user may be provided with profile information for the user who originated the alert 175. Similarly, the originating user may be provided with profile information for all users who accept the alert 175. The users may then determine whether to connect, for example, by selecting the connect component 1009 or similar component. By presenting a profile of a user who accepted an alert 175 to the user that generated the alert 175, the user can then determine whether the user who accepted the alert 175 is, in fact, the person described in the message 178.

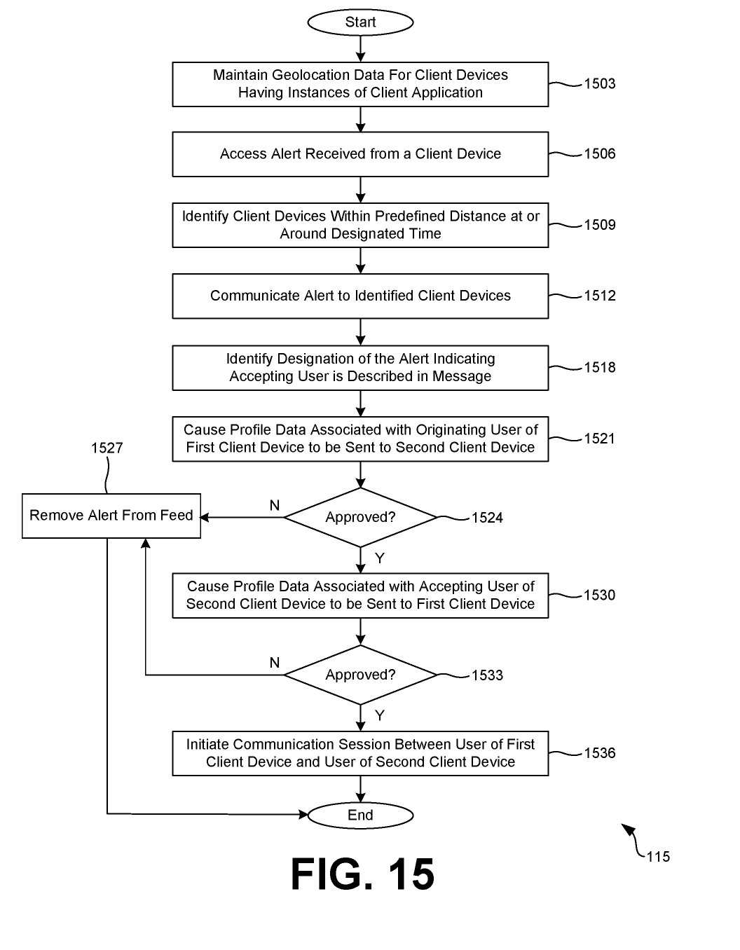

Referring next to FIG. 15, shown is a flowchart that provides one example of the operation of a portion of the alert management application 115 according to various embodiments. It is understood that the flowchart of FIG. 15 provides merely an example of the many different types of functional arrangements that may be employed to implement the operation of the portion of the alert management application 115 as described herein. As an alternative, the flowchart of FIG. 115 may be viewed as depicting an example of elements of a method implemented in the computing environment 103 according to one or more embodiments.

Beginning with step 1503, the computing environment 103 maintains geolocation data 182 for a plurality of client devices 106 that, for example, have instances of the client application 169 installed thereon. In some embodiments, the geolocation data 182 obtained from the client devices 106 may be periodically obtained by periodically polling at least one location module of the client device 106, such as a GPS module, a WiFi module, or other suitable location module. In some embodiments, the geolocation data 182 may include user location check-ins made using a social networking application. The geolocation data 182 may comprise locations of users as well as times at which the users were at those particular locations.

Next, in step 1506, an alert 175 generated via an instance of the client application 169 is received by the computing environment 103 and accessed. In various embodiments, the alert 175 may comprise a message 178 generated by a user of the client application 168 that identifies physical characteristics of a person with whom the originating user wants to connect. The computing environment 103 associates the alert 175 with a location of the client device 106. The location may be a place in which the originating user and the person described in the message 178 were located at the same time. In various embodiments, the location is specified by the originating user. In other embodiments, the location is determined using geolocation data 182 at a time the alert 175 is generated.

Next, in step 1509, the computing environment 103 identifies a subset of the client devices 106 that were located within a predefined distance (e.g., within a few blocks, within a mile, or other threshold distance) of the location and within a predefined threshold of the time (e.g., within ten minutes, five minutes, or other threshold time) based at least in part on the geolocation data 182 collected for the client devices 106. In various embodiments, the subset may be identified by querying a structured database using a structure query language (SQL).

In step 1512, the alert 175 is communicated to individual ones of the client devices 106 in the subset. In other words, the client devices 106 within a predefined distance of the location associated with the alert 175 and being within the predefined distance at a time (or within a time threshold) associated with the alert 175 will receive the alert 175. Communication of the alert 175 to the client devices 106 may include a push notification, a short message service (SMS) message, or other data communicated to instances of the client application 169. As noted above, the client application 169 may be configured to encode the alert 175, as well as other alerts 175, in an alert feed 403.

In some embodiments, the user who originated the alert 175 may designate constraints associated with the alert 175 and those devices to which the alert 175 is communicated. For example, the user may specify that the alert 175 only be communicated to female users of the client application 169. The specification may be made when the alert 175 is generated or by specifying preferences 133 in association with his or her user profile.

The client application 169 may allow the users to indicate whether they are the person described in the message 178. For example, if a user thinks that he or she was described in the message 178, the user may select or otherwise manipulate an identification component 192.

Accordingly, in step 1518, the computing environment 103 may detect the manipulation of the identification component 192 by receiving a suitable communication from the client application 169. In other words, a designation is received by the computing environment 103 from at least one of the client devices 106 that received the alert 175, where the designation indicates that a user of the at least one of the client devices 106 is associated with (e.g., being described in) the message 178.

Next, in step 1521, profile data 130 associated with the user that originated the alert 175 from a first client device 106a is communicated to a second client device 106b corresponding to the user who made the designation (e.g., selected the identification component 192). The user who made the designation (e.g., the accepting user), may indicate whether to accept the connection attempt made by the originating user, for example, based on the profile data 130 of the originating user.

In step 1524, it may be determined whether the user who created the designation accepted or approved the connection attempt. For example, a dialog 1003 may be shown in the user interface 172 of a client device 106 corresponding to the accepting user until the user selects or otherwise manipulates a dismiss component 1006, a connect component 1009, and/or a view profile component 1012. The selection or manipulation of the dismiss component 1006 may remove the dialog 1003 from the user interface 172 where, in step 1527, the alert 175 may be removed from a feed of the client application 169 for the accepting user.

However, the selection or manipulation of the connect component 1009, in step 1530, may cause profile data 130 associated with the accepting user on the second client device 106b to be communicated to the first client device 106a corresponding to the originating user. The user who originated the alert 175 may indicate whether to accept the connection attempt for example, based on the profile data 130 of the accepting user.

In 1533, it is determined whether the originating user accepted the connection attempt furthered by the accepting or approving user. As may be appreciated, if the accepting user is not, in fact, the person described in the message 178, it may be readily apparent to the originating user as the originating user is provided access to profile data 130 (e.g., a name, a gender, or a photo) for the accepting user. If the user denies the connection attempt between the accepting user, the alert 175 may be removed from an alert feed 403 of the accepting user.

If the originating user approves of the connection with the accepting user, in step 1536, the computing environment 103 may form an association between the two users and/or present the user with a communication component that allows the users to communicate in a communication session 1303.

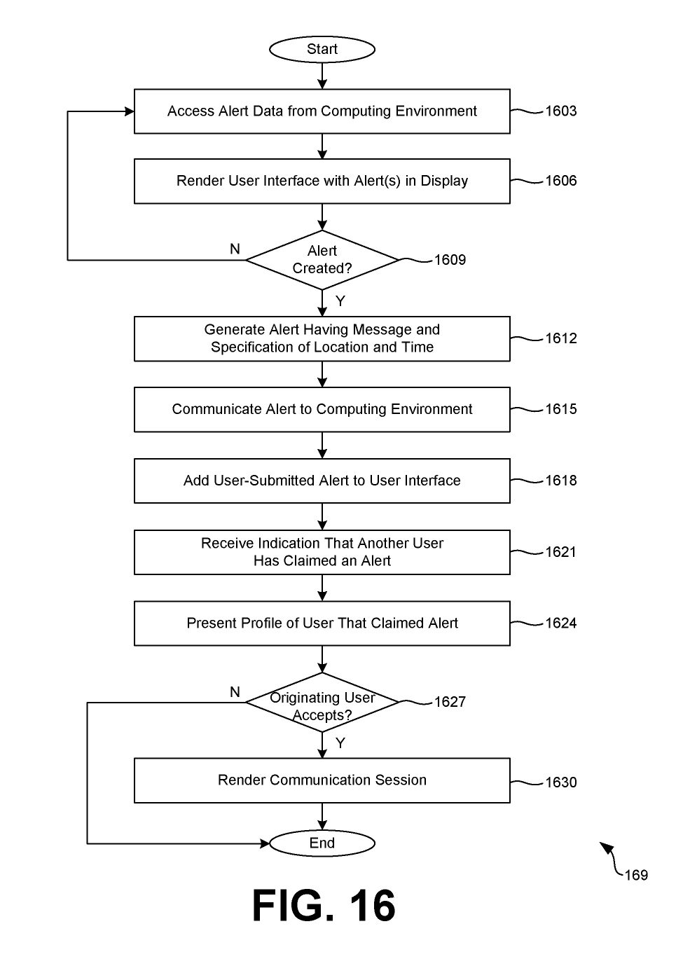

Referring next to FIG. 16, shown is a flowchart that provides one example of the operation of a portion of the client application 169 according to various embodiments. It is understood that the flowchart of FIG. 16 provides merely an example of the many different types of functional arrangements that may be employed to implement the operation of the portion of the client application 169 as described herein. As an alternative, the flowchart of FIG. 16 may be viewed as depicting an example of elements of a method implemented in the client device 106 according to one or more embodiments.

As noted above, the computing environment 103 maintains geolocation data 182 for a plurality of client devices 106 that, for example, have instances of the client application 169 installed thereon. The geolocation data 182 may comprise locations of users as well as times at which the users were at those particular locations. Various users of instances of the client application 169 may create alerts 175 to have those alerts 175 communicated to users that were at a specified location at a specified time.

In various embodiments, the alert 175 may comprise a message 178 generated by a user of the client application 168 that identifies physical characteristics of a person with whom the originating user wants to connect. The computing environment 103 associates the alert 175 with a location of the client device 106. The location may be a place in which the originating user and the person described in the message 178 were located at the same time. In various embodiments, the location is specified by the originating user. In other embodiments, the location is determined using geolocation data 182 at a time the alert 175 is generated.

Starting with step 1603, the client application 169 accesses alert data (e.g., comprising alerts 175) applicable to a particular client device 106 received from the computing environment 103 over the network 109. For a given alert 175, the computing environment 103 identifies client devices 106 that were located at a specified location at a specified time associated with the alert 175 using the geolocation data 182. The alert 175 may be communicated to the identified client devices 106 using a push notification, a SMS message, or data that may be interpreted by the client application 169, such as user interface data.

If a client device 106 receives an alert 175, it may be assumed that the client device 106 was in a specified location at a specified time associated with the alert 175. Accordingly, in step 1606, the alert 175 may be shown in a user interface 172 of the client application 169, for example, in the alerts feed 403. For example, in the example shown in FIG. 4, the client device 106 was located at the “59^{th} St. Subway at 10:30 PM” (e.g., indicated by the first alert 175a) and at “84^{th} St. and 5^{th} Ave. Central Park at 7:30 PM” (e.g., indicated by the second alert 175b).

Further, the client application 169 facilitates the creation of alerts 175. For example, in FIG. 3, the client application 169 may render a compose screen 303 that allows a user to create an alert 175. In various embodiments, the compose screen 303 comprises a field 306 that allows the user to specify whether the person described in the message 178 is a male or a female. As may be appreciated, the computing environment 103 will only make the alert 175 accessible to those who have specified the same gender in his or her user profile. Further, the computing environment 103 will only make the alert 175 accessible to predefined preferences stored in the preferences 133 of user data 124.

A text input field 309 of the compose screen 303 allows users to input a message 178 using a suitable input device, such as a physical or virtual keyboard. In various embodiments, the message 178 describes a person who the user saw in a location at a particular time. The client application 169 may allow the user to specify the location and/or the time such that the computing environment 103 makes the alert 175 accessible to client device 106 in the specified location at the specified time. In other embodiments, the computing environment 103 utilizes a current location of the client device 106 and a time the alert 175 was generated, for example, by a selection of a drop alert component 312.

Referring back to FIG. 16, if an alert 175 is not created, the process may continue accessing alert data as shown in step 1603. If an alert 175 is created, the process may proceed to step 1612 where one or more data packets are generated for the alert 175 comprising, for example, a message 178, a specification of a location associated with the alert 175, a specification of a time associated with the alert 175, and/or other information. In step 1615, the one or more data packets of the alert 175 are communicated to the computing environment 103 via the alert management application 115 or other suitable application.

Once received, the computing environment 103 identifies a subset of the client devices 106 that were located within a predefined distance (e.g., within a few blocks, within a mile, or other threshold distance) of the location specified in the alert 175 and within a predefined threshold of the time (e.g., within ten minutes, five minutes, or other threshold time) based at least in part on the geolocation data 182 collected for the client devices 106. In various embodiments, the subset may be identified by querying a structured database using a structure query language (SQL). In step 1618, the client application 169 may add the alert 175 to a user interface 175, for example, in the alert feed 403.

Next, in step 1621, an indication may be received that one or more users have accepted the alert 175, e.g., the users have indicated that they are the person identified in the message 178 of the alert 175. If so, in step 1624, profile data for the one or more accepting users may be presented to the user that originated in the alert 175 via the client application 169. For example, in FIGS. 9 and 10, an event component 903 or a dialog 1003 may be shown to notify the user that one or more users have accepted the alert 175. The user may view their profile, as shown in FIG. 14 and may accept or deny creating a connection between the users.

In step 1627, it is determined whether the originating user accepts one of the profiles as being the person described in the message 178 of the alert 175. For example, the originating user may select the connect component 1009 shown in FIG. 10. If the user accepts a profile, in step 1630, a communication session 1303 may be created, allowing the two users to communicate. If the user does not accept a profile, then the process ends.

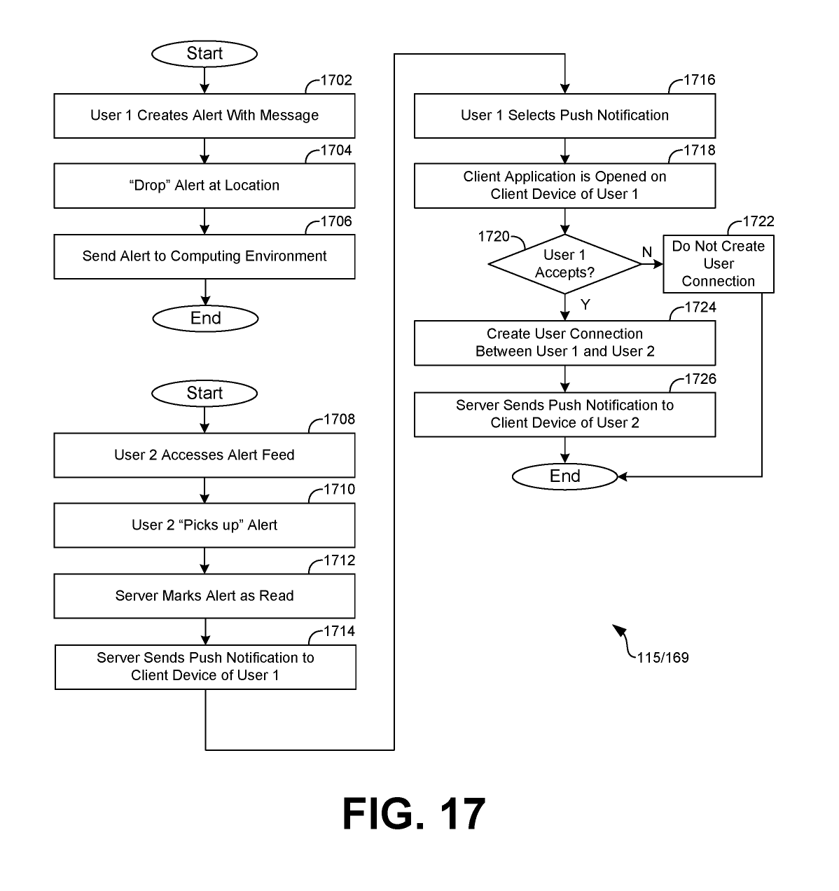

Referring next to FIG. 17, shown is a flowchart that provides one example of the operation of a portion of different instances of the client application 169 according to various embodiments.

Beginning with step 1702, a first user (e.g., “User 1”) creates an alert 175 having a message 178. In addition, during creation of the alert 175, the user may specify a location and/or a time. For example, if John was at a coffee shop, John may have noticed an attractive woman as she was leaving the coffee shop. As John did not get the opportunity to speak with the woman, it may be unlikely and even impossible for John to meet the woman in the future.

John, a user of the client application 169, may create an alert 175 to communicate to users of the client application 169 that were at (or near) the coffee shop at the same time as John. This may be referred to as “dropping” an alert 175 at a particular location (also referred to as “dropping a breadcrumb”), as shown in step 1704. In actuality, in step 1706, the alert created by the first user is communicated to the computing environment 103, for example, to identify users that were at the coffee shop at the same time as John.

The computing environment 103 identifies client devices 106 that were at the specified location at or around the specified time and communicates the alert 175 to the identified client devices 106. Accordingly, in step 1708, a second user will access his or her alert feed 403 where the alert 175 generated by the first user will be made available. The second user may accept (or “pick up”) the alert 175. In step 1712, the computing environment 103 may mark the alert 175 as having been read by the second user. In some embodiments, the users that have read and/or picked up an alert 175 may be shown to the first users.

In step 1714, the server may send a push notification, SMS message, or other notification to the first user that indicates that the second user picked up the alert 175. When, in step 1716, the first user selects the push notification or other communication, in step 1718, the client application 169 may be opened on the client device 106 of the first user. At this time, information associated with the second user (e.g., the accepting user) may be shown to the first user. The information may include a profile screen 1703 or excerpts from the second user's profile.

As the first user is shown a photo, a name, a gender, an age, and/or other information associated with the second user, the first user may determine whether the second user is, in fact, the person described in the message 178. If so, the first user may accept (or deny) the second user, as shown in step 1720. If the first user does not accept the second user, in step 1722, no connection is made between the first user and the second user.

However, if the first user accepts the second user, in step 1724, the computing environment 103 creates an association and/or a connection between the first user and the second user. The connection may include causing the client application 169 to create a communication session 1303 between the two users. In addition, in step 1726, a push notification (or other communication) may be sent to the second user to notify the second user that a connection has been created with the first user. Thereafter, the process proceeds to end.

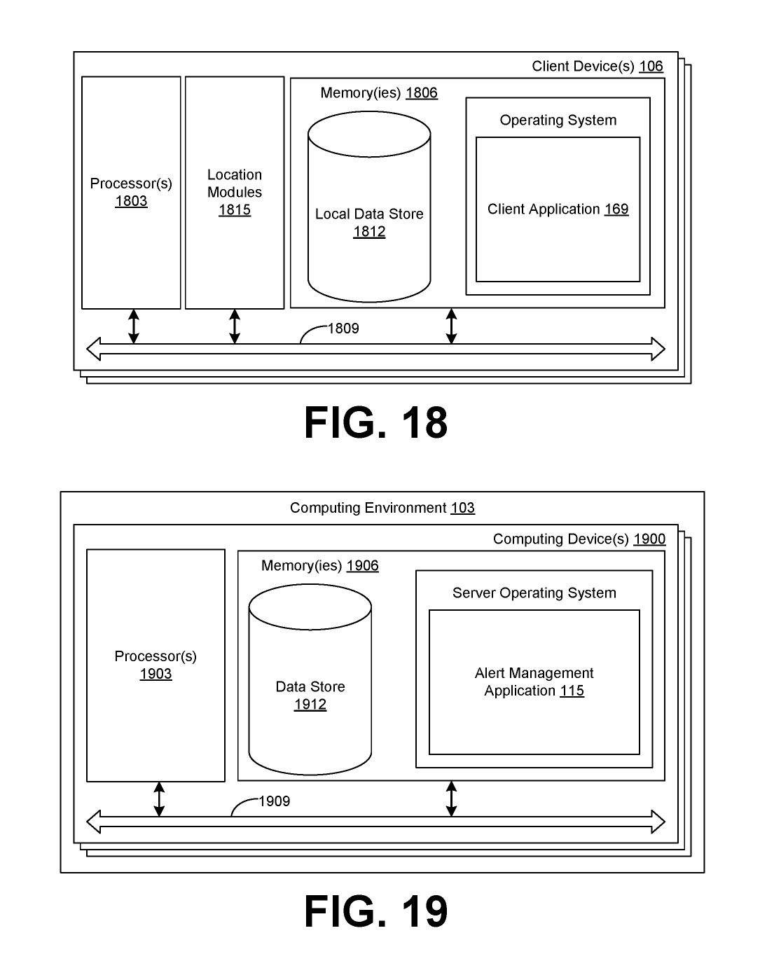

With reference to FIG. 18, shown is a schematic block diagram of the client device 106 according to an embodiment of the present disclosure. The client device 106 includes one or more computing devices. Each computing device includes at least one processor circuit, for example, having a processor 1803 and a memory 1806, both of which are coupled to a local interface 1809. To this end, each computing device may comprise, for example, a smartphone, a tablet computer, a laptop computer, or like device. The local interface 1809 may comprise, for example, a data bus with an accompanying address/control bus or other bus structure as can be appreciated.

Stored in the memory 1806 are both data and several components that are executable by the processor 1803. In particular, stored in the memory 1806 and executable by the processor 1803 are the client application 169, and potentially other applications. Also stored in the memory 1806 may be a local data store 1812 and other data. In various embodiments, the local data store 1812 may comprise SQLite. In addition, an operating system, such as a mobile operating system (e.g., ANDROID®, iOS®, or WINDOWS®, WINDOWS® MOBILE), may be stored in the memory 1806 and executable by the processor 1803. The client device 106 can also include one or more location modules 1815, such as a GPS module, a WiFi module, or other suitable location modules.

With reference to FIG. 19, shown is a schematic block diagram of the computing environment 103 according to an embodiment of the present disclosure. The computing environment 103 includes one or more computing devices 1900. Each computing device 1900 includes at least one processor circuit, for example, having a processor 1903 and a memory 1906, both of which are coupled to a local interface 1909. To this end, each computing device 1900 may comprise, for example, at least one server computer or like device. The local interface 1909 may comprise, for example, a data bus with an accompanying address/control bus or other bus structure as can be appreciated.

Stored in the memory 1906 are both data and several components that are executable by the processor 1903. In particular, stored in the memory 1906 and executable by the processor 1903 are the alert management application 115, and potentially other applications. Also stored in the memory 1906 may be a data store 112 and other data. In addition, an operating system, such as a server operating system (e.g., APACHE®) may be stored in the memory 1906 and executable by the processor 1903.

It is understood that there may be other applications that are stored in the memory 1906 and are executable by the processor 1903 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1906 and are executable by the processor 1903. In this respect, the term “executable” means a program file that is in a form that can ultimately be run by the processor 1903. Examples of executable programs may be, for example, a compiled program that can be translated into machine code in a format that can be loaded into a random access portion of the memory 1906 and run by the processor 1903, source code that may be expressed in proper format such as object code that is capable of being loaded into a random access portion of the memory 1906 and executed by the processor 1903, or source code that may be interpreted by another executable program to generate instructions in a random access portion of the memory 1906 to be executed by the processor 1903, etc. An executable program, comprising program instructions interpretable by the processor 1903, may be stored in any portion or component of the memory 1906 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1906 is defined herein as including both volatile and nonvolatile memory and data storage components. Volatile components are those that do not retain data values upon loss of power. Nonvolatile components are those that retain data upon a loss of power. Thus, the memory 1906 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1903 may represent multiple processors 1903 and/or multiple processor cores and the memory 1906 may represent multiple memories 1906 that operate in parallel processing circuits, respectively. In such a case, the local interface 1909 may be an appropriate network that facilitates communication between any two of the multiple processors 1903, between any processor 1903 and any of the memories 1906, or between any two of the memories 1906, etc. The local interface 1909 may comprise additional systems designed to coordinate this communication, including, for example, performing load balancing. The processor 1903 may be of electrical or of some other available construction.

Although the client application 169, the alert management application 115, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 15, 16, and 17 show the functionality and operation of an implementation of portions of the client application 169 and the alert management application 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1903 in a computer system or other system. The machine code may be converted from the source code, etc. If embodied in hardware, each block may represent a circuit or a number of interconnected circuits to implement the specified logical function(s).

Although the flowcharts of FIGS. 15, 16, and 17 show a specific order of execution, it is understood that the order of execution may differ from that which is depicted. For example, the order of execution of two or more blocks may be scrambled relative to the order shown. Also, two or more blocks shown in succession in FIGS. 15, 16, and 17 may be executed concurrently or with partial concurrence. Further, in some embodiments, one or more of the blocks shown in FIGS. 15, 16, and 17 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the client application 169 and the alert management application 115, that comprises software or code can be embodied in any non-transitory computer-readable medium for use by or in connection with an instruction execution system such as, for example, a processor 1903 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the client application 169 and the alert management application 115, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1900, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying program instructions executable by at least one computing device that, when executed by the at least one computing device, cause that at least one computing device to:
access an alert generated via a client application executable on a client device comprising a message, wherein the alert specifies a location and a time;
access geolocation data received from a plurality of other client devices obtained from a global positioning system (GPS) module or a wireless fidelity (WiFi) module, wherein the geolocation data for each of the other client devices comprises a timestamp;
identify a subset of a plurality of other client devices that were located within a predefined distance of the location within a predefined threshold of the time based at least in part on the geolocation data and the timestamp, wherein identifying the subset comprises applying at least one localization technique using the geolocation data;
cause transmission of the alert to individual ones of the plurality of other client devices in the subset, wherein the client application is configured to encode the alert in an alert feed;
access a designation received from at least one of the plurality of other client devices in the subset, wherein the designation indicates that a user of the at least one of the plurality of other client devices is associated with the message;
cause profile data associated with the user of the at least one of the plurality of other client devices to be communicated to the client device;
access an approval or a disapproval received from the client device in association with the profile data; and
in response to an approval, cause a communication session in the client application to become accessible, wherein the communication session facilitates communication between the at least one of the plurality of other client devices and the client device.

2. The non-transitory computer-readable medium of claim 1, wherein the geolocation data is obtained from each of the other client devices using at least one location module, the at least one location module comprising at least one of a global positioning system (GPS) module or a wireless fidelity (WiFi) module.

3. The non-transitory computer-readable medium of claim 1, wherein the message comprises information associated with an identity of the user of the at least one of the plurality of other client devices.

4. The non-transitory computer-readable medium of claim 1, wherein the client application further comprises a mobile application executable by a mobile operating system.

5. A system, comprising:
at least one computing device;
program instructions executable by the at least one computing device that, when executed, cause the at least one computing device to:
access an alert generated via a client application executable on a client device, the alert comprising a message generated via the client application, wherein the alert is associated with a location a time;
identify a subset of a plurality of other client devices that comprise a plurality of instances of the client application that were located within a predefined distance of the location within a predefined threshold of the time;
cause transmission of the alert to individual ones of the plurality of other client devices in the subset, wherein the plurality of instances of the client application are configured to encode the alert in an alert feed on a respective one of the plurality of other client devices;
access a designation received from at least one of the plurality of other client devices in the subset, wherein the designation indicates that a user of the at least one of the plurality of other client devices is associated with the message; and
cause profile data associated with the user of the at least one of the plurality of other client devices to be communicated to the client device.

6. The system of claim 5, wherein the at least one application further comprises program instructions that, when executed, cause the at least one computing device to access geolocation data received from a plurality of other client devices, the geolocation data comprising a timestamp; and
identify the subset of the plurality of other client devices that were located within the predefined distance of the location within the predefined threshold of the time using at least the geolocation data.

7. The system of claim 6, wherein the geolocation data is obtained using at least one location module of the client device, the at least one location module comprises at least one of a global positioning system (GPS) module or a wireless fidelity (WiFi) module.

8. The system of claim 5, wherein the at least one application further comprises program instructions that, when executed, cause the at least one computing device to access an approval or a disapproval received from first client device in association with the profile data.

9. The system of claim 8, wherein the at least one application further comprises program instructions that, when executed, cause the at least one computing device to, in response to the approval, cause a communication session in the client application to become accessible, wherein the communication session facilitates communication between the at least one of the plurality of other client devices and the client device.

10. The system of claim 5, wherein the alert further comprises a predefined gender of the user of the at least one of the plurality of other client devices, wherein the individual ones of the other client devices in the subset are further identified based at least in part on the predefined gender.

11. The system of claim 5, wherein the alert further comprises a predefined characteristic of the user of the at least one of the plurality of other client devices, wherein the individual ones of the other client devices in the subset are further identified based at least in part on the predefined characteristic.

12. The system of claim 5, wherein at least a portion of the profile data associated with the user of the client device to be presented on the at least one of the plurality of other client devices from a social networking application over the network.

13. A computer-implemented method, comprising:
causing, by a client device comprising at least one hardware processor, a communication of an alert generated via a client application to be communicated to a remote computing environment, the alert comprising a message generated via the client application, wherein the alert is associated with a location of the client device and a time; and
rendering, by the client device, profile data associated with a user of a respective one of a plurality of other client devices received from the remote computing environment, wherein the user of the respective one of the plurality of other client devices is identified by the remote computing environment by:
identifying a subset of the plurality of other client devices that were located within a predefined distance of the location within a predefined threshold of the time;
causing a transmission of the alert to individual ones of the plurality of other client devices in the subset to be rendered in a feed; and
receiving a designation from the respective one of the plurality of other client devices in the subset, wherein the designation indicates that a user of the respective one of the plurality of other client devices is associated with the message.

14. The computer-implemented method of claim 13, wherein the computing environment identifies the respective one of the plurality of other client devices by accessing geolocation data received from a plurality of other client devices, the geolocation data comprising a timestamp.

15. The computer-implemented method of claim 14, wherein the geolocation data is obtained using at least one location module of the plurality of other client devices, the at least one location module comprises at least one of a global positioning system (GPS) module or a wireless fidelity (WiFi) module.

16. The computer-implemented method of claim 13, further comprising communicating, by the client device, an approval or a disapproval in association with the profile data in response to a user input.

17. The computer-implemented method of claim 13, further comprising causing, by the client device, a rendering of a communication session, wherein the communication session facilitates communication between the user of the at least one of the plurality of other client devices and a user of the client device.

18. The computer-implemented method of claim 13, wherein the alert further comprises a predefined gender of the user of the at least one of the plurality of other client devices, wherein the individual ones of the other client devices in the subset are further identified based at least in part on the predefined gender.

19. The computer-implemented method of claim 13, wherein the alert further comprises a predefined characteristic of the user of the at least one of the plurality of other client devices, wherein the individual ones of the other client devices in the subset are further identified based at least in part on the predefined characteristic.

20. The computer-implemented method of claim 13, wherein at least a portion of the profile data associated with the user of the client device to be presented on the at least one of the plurality of other client devices is obtained from a social networking application over the network.
